(19) United States
(12) Patent Application Publication
(10) Pub. No.: US 2003/0218268 A1
(43) Pub. Date: Nov. 27, 2003

(54) Method of synthesizing negative thermal expansion ceramics

(75) Inventors: Yuhkoh Morito, Kanagawa (JP); Kouji Takahashi, Tochigi (JP); Takuya Hashimoto, Tokyo (JP)

Correspondence Address: GREENBLUM & BERNSTEIN, P.L.C., 1950 ROLAND CLARKE PLACE, RESTON, VA, 20191, US

(73) Assignee: Moritex Corporation, Tokyo (JP)

(21) Appl. No.: 10/442,972

(22) Filed: May 22, 2003

(30) Foreign Application Priority Data
May 23, 2002 (JP) 2002-149551

(51) Int. Cl. C04B 33/32; B29C 67/00; B29C 59/00

(52) U.S. Cl. 264/122; 264/125; 264/642

(57) ABSTRACT

A method of synthesizing negative-thermal-expansion ceramics of synthesizing Zr₍₁₋ₓ₎XₓW₂O₈ in which X represents a substituent element for zirconium Zr, and 0≦x <<1, having a negative thermal expansion coefficient, the method comprising mixing two mols of tungsten trioxide WO₃ and one mol of the sum of zirconium oxide ZrO₂ and a substituent element X in accordance with substitution amount x at a stoichiometrical ratio, further mixing the thus obtained starting material in a powdery form having a particle size distribution including two groups of particles comprising smaller diameter particles with a particle size of 0.1 to 1 μm and larger diameter particles with a particle size of 5 to 50 μm, and then sintering the staring powder being placed in a desired molding die whereby negative-thermal-expansion ceramics having an increased density equal with or higher than that of press molding products and of a larger size than that of the press molding products without press-molding the starting powder can be synthesized.

### BACKGROUND OF THE INVENTION

1. Field of the Invention

The present invention concerns a method of synthesizing negative-thermal-expansion ceramics having a negative thermal expansion coefficient, which is particularly suitable to synthesis of high density negative-thermal-expansion ceramics.

2. Statement of Related Art

Negative thermal expansion ceramics having negative thermal expansion coefficients such as ZrW₂O₈ have been expected in recent years for their application uses as materials capable of offsetting the effects of change of the shape due to temperature change of components and the like which involve the problem of control for thermal expansion.

For the method of synthesizing such negative-thermal-expansion ceramics, a solution method or a solid phase reaction method has been known.

According to the solution method (refer to U.S. Pat. Nos. 5,322,559, 5,433,778, 5,514,360, 5,919,720 and 6,183,716), single phase polycrystalline bodies of negative thermal expansion oxide ZrW₂O₈ can be synthesized by the following procedures (1) to (7).

(1): Preparation of an aqueous solution A comprising ZrOCl₂. 8H₂O containing 0.5 mol of Zr and an aqueous solution B comprising (NH₄)₆H₂W₁₂O₄₀ containing 1 mol of W.

(2) Addition of the aqueous solutions A and B by 50 ml under stirring while dropping little by little to 25 ml of water.

(3): Continuous stirring of formed white precipitates for 10 hours

(4): Addition of 125 mol of 6 mol HCl, followed by reflux for 48 hours.

(5): Cooling to a room temperature, followed by decantation and filtration.

(6): Leaving resultant solids for 7 days.

(7): Heat treatment in air at 600° C.

Further, according to the solid phase reaction method, single phase polycrystalline bodies of negative-thermal-expansion ceramics ZrW₂O₈ can be synthesized by the following procedures (1) to (5).

(1): mixing powder of ZrO₂ and WO₃ at a determined compositional ratio,

(2): vacuum sealing in a silica tube,

(3): heat treatment at 1150° C. for 12 hours,

(4): pulverizing of the resultant white powder,

(5): heat treatment in a platinum crucible at 1200° C. for 12 hours.

By the way, when the negative-thermal-expansion ceramics are applied for thermal expansion controlling components, it is necessary to synthesize them in a great amount at a reduced cost.

However, in the solution method described above, since the starting materials ZrOCl₂.8H₂O and (NH₄)₆H₂W₁₂O₄₀ are poor in the stability in air, they are difficult to be used, a long time is required for the pretreatment to the heat treatment and, further, a large-scaled apparatus is necessary, as well as a great amount of chemicals other than the starting materials are required to increase the manufacturing cost.

The solid phase reaction method requires a large-scaled facility for vacuum sealing into the silica tube and the sealing operation is troublesome.

In addition, in any of the synthesis methods described above, the negative-thermal-expansion oxides ZrW₂O₈ can be made only in a small amount of less than 1 g for once and it can not cope with the demand for mass synthesis.

In view of the above, the present applicant has already proposed a method of press molding a starting powder into pellets to eliminate voids between starting particles and then sintering them for synthesizing high density negative-thermal-expansion ceramics in a great amount and at a reduced cost (Japanese patent Laid Open No. 2002-104877).

In a case of synthesizing the negative-thermal-expansion ceramics ZrW₂O₈ by the proposed method, zirconium oxide ZrO₂ and tungsten trioxide WO₃ are at first pulverized in an alumina mortar or the like and mixing them at a stoichiometrical molar ratio of 1:2.

Then, after press molding the starting powder into pellets under a pressure of 1500 to 2500 kg/cm², they are enveloped in an platinum foil and then sintered by applying a heat treatment while being kept at 1200° C. for 72 hours in atmospheric air.

According to this method, negative-thermal-expansion ceramics ZrW₂O₈ of high practical usefulness increased to a high density of about 76% of the theoretical density can be synthesized in a great amount and at a reduced cost.

However, since the starting powder has to be press-molded, the shape is restricted and, accordingly, the size of one sintered body is of about 20 mm diameter and 2 to 3 mm thickness at the greatest although it is said that this can be synthesized in a relatively great amount. If the size is made further larger, since voids are left between each of the starting particles, voids are formed also in the sintered negative-thermal-expansion ceramics to make them extremely fragile.

In view of the above, the present invention has a technical subject of enabling synthesis of negative-thermal-expansion ceramics having density equal with or higher than the press-molded body, and of larger size than that of press-molded body without press-molding the starting powders.

### SUMMARY OF THE INVENTION

The foregoing subject can be solved in accordance with the present invention by a method of synthesizing negative-thermal-expansion ceramics of synthesizing Zr₍₁₋ₓ₎XₓW₂O₈ in which X represents a substituent element for zirconium Zr, and 0≦x<<1, having a negative thermal expansion coefficient, the method comprising mixing two mols of tungsten trioxide WO₃ and one mol of the sum of zirconium oxide ZrO₂ and a substituent element X in accordance with substitution amount x at a stoichiometrical ratio, further mixing the thus obtained starting material in a powdery form having a particle size distribution including two groups of particles comprising smaller diameter particles with a particle size of 0.1 to 1 μm and larger diameter particles with a particle size of 5 to 50 μm, and then sintering the staring powder being placed in a desired molding die.

According to the present invention, since the starting powders has such a particle size distribution as including two groups comprising smaller diameter particles with a particle size of 0.1 to 1 μm and larger diameter particles with a particle size of 5 to 50 μm, in which smaller diameter particles intrude into voids formed by agglomeration of larger diameter particles to each other and fill the voids, a sintered body at high density can be obtained with no formation of voids.

It has been found according to the experiment made by the inventors that fine voids are formed inside the sintered body to result in a porous body both in a case only consisting of larger diameter particles and in a case only consisting of smaller diameter particles.

It is considered that voids are formed between agglomerated particles in a case only consisting of larger diameter particles. In a case only consisting of smaller diameter particles, they are agglomerated to form individual larger diameter secondary particles respectively. While sintering proceeds with no voids in each of the secondary particles, voids are also formed between the agglomerated particles, like the larger diameter particles, when the secondary particles are agglomerated to each other.

Accordingly, it is considered that the high density can be attained by the particle size distribution of the starting powder such that they include two groups of smaller diameter particles with a particle size of 0.1 to 1 μm and larger diameter particles with a particle size of 5 to 50 μm.

When negative-thermal-expansion ceramics ZrW₂O₈ was synthesized from zirconium oxide ZrO₂ and tungsten oxide WO₃ at substitution amount x=0 by using the method described above, synthesis of large sized negative-thermal-expansion ceramics of 50 mm diameter and 35 mm height could be obtained and the negative-thermal-expansion ceramics ZrW₂O₈ of a density increased to about 76% of the theoretical density was obtained like that in the press molding.

Further, the negative-thermal-expansion ceramics Zr₍₁₋ₓ₎YₓW₂O₈ synthesized from zirconium oxide ZrO₂, yttrium oxide Y₂O₃ corresponding to the constituent amount x and tungsten trioxide WO₃ according to this method can be increased more in the density than the negative-thermal-expansion ceramics ZrW₂O₈ at substitution amount x=0 without by way of press-molding.

According to the experiment made by the inventors, the density of the negative-thermal-expansion ceramics is about 80% of the theoretical density at a substitution amount x of 0.005 or more, exceeds 80% of the theoretical density at a substitution amount x of 0.01 or more, exceeds 85% of the theoretical density at a substitution amount x of 0.015 or more, and reaches 96% of the theoretical density at a substitution amount x of 0.02.

### BRIEF DESCRIPTION OF THE DRAWINGS

FIG. 1 is an explanatory view showing the method of synthesizing negative-thermal-expansion ceramics according to the present invention.

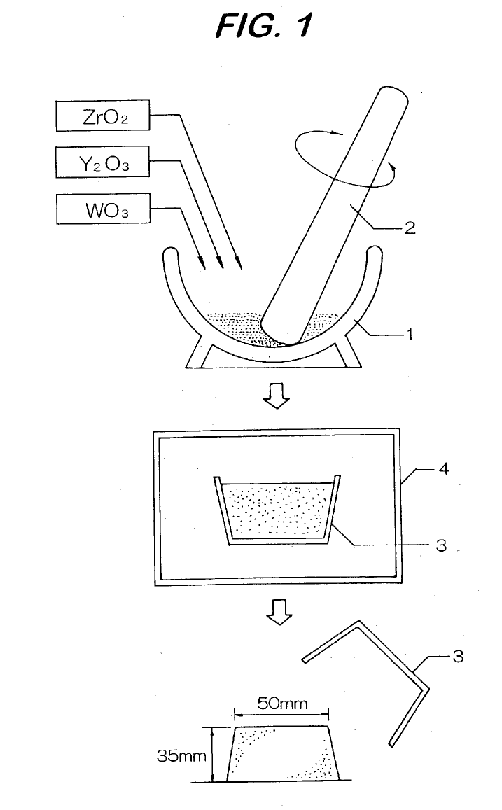

FIG. 2 is a graph showing a particle size distribution:

FIG. 3 is a graph showing a relation between the substitution amount and the density; and

FIG. 4 is a graph showing the thermal deformation behavior.

### PREFERRED EMBODIMENTS OF THE INVENTION

A preferred embodiment of the present invention is to be described specifically with reference to the drawings.

Description is to be made to a case of synthesizing negative-thermal-expansion ceramics Zr₍₁₋ₓ₎YₓW₂O₈ (0≦x<<1) by substituting zirconium Zr in negative-thermal-expansion ceramics ZrW₂O₈ with yttrium Y.

At first, a starting material powder prepared by mixing one mol of the sum of zirconium oxide ZrO₂ and yttrium oxide Y₂O₃ in accordance with a substitution amount x to two mols of tungsten trioxide WO₃ at a stoichiometrical ratio was placed in an alumina mortar 1, and mixed by a pestle such that the starting mixture was powdered to have a particle size distribution including two groups of smaller diameter particles with a particle size of 0.1 to 1 μm and larger diameter particles with a particle size of 5 to 50 μm.

The starting powder when mixed manually for about 20 min was dispersed in sodium hexamethaphosphate and measured by a laser diffraction particle size analyzer (SALD-300 S manufactured by Shimadzu Seisakusho).

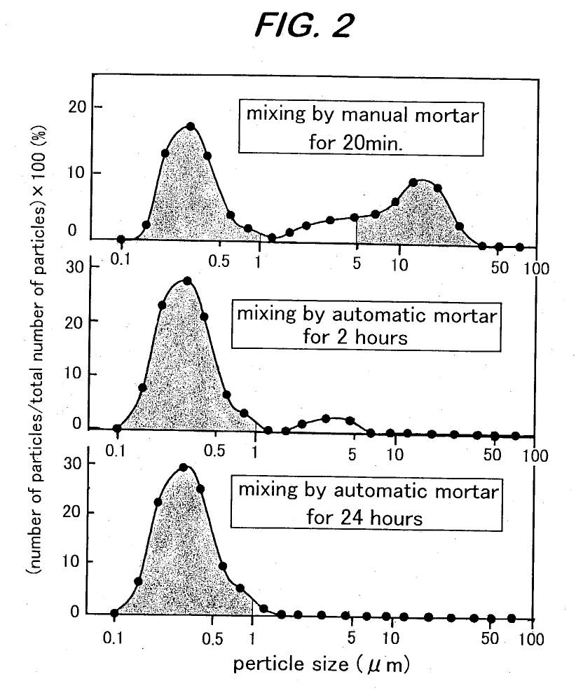

FIG. 2 shows an example of a particle size distribution of the starting powder obtained as described above. It can be seen that the starting powder is grouped into two parts including smaller diameter particles with a particle size of 0.1 to 1 μm and larger diameter particles with a particle size of 5 to 50 μm. In this example, the number of smaller diameter particles with a particle size of 0.1 to 1 μm is about 55% for the total number of particles, while the number of larger diameter particles with a particle size of 5 to 50 μm is about 40% for the total number of particles.

For comparison, a particle size distribution of the starting powder formed by mixing the starting powder in an automatic mortar for 2 hours and a particle size distribution of the starting powder formed by mixing the starting powder in an automatic mortar for 24 hours are shown.

In the experiment, corresponding to the substitution amount; x=0, 0.005, 0.01, 0.015, and 0.02, the mixing ratio Zr:Y:W was set to \mathring{1} 1:0:2, \mathring{2} 0.995:0.005:2, \mathring{3} 0,99:0.01:2, \mathring{4} 0.985:0.015:2, and \mathring{5} 0.98:0.02:2. The particle size distribution was conditioned such that the number of particles with a particle size of 0.1 to 1 μm was 20 to 60% for the number of entire particles while the number of particles with a particle size of 5 to 50 μm was 20 to 50% for the number of entire particles.

The thus obtained starting powder was placed in a platinum crucible 3 of 50 mm diameter and 40 mm depth, which was set in an electric furnace 4 and sintered by heating in atmospheric air at a temperature (for example, 1200° C.) that is higher than the sintering start temperature (1150° C.) and lower than the melting point (1250° C.) for 72 hours and then cooled in air at room temperature to synthesize negative-thermal-expansion ceramics of 35 mm diameter and 30 mm height.

The size could be enlarged outstandingly compared with negative-thermal-expansion ceramics of a pellet shape of 20 mm diameter and 2 to 3 mm thickness synthesized by the pressing method.

Thus, five types of negative-thermal-expansion ceramics (1) ZrW₂O₈, (2) Zr_{0.995}Y_{0.005}W₂O₈, (3) Zr_{0.99}Y_{0.01}W₂O₈, (4) Zr_{0.985}Y_{0.015}W₂O₈, and (5) Zr_{0.98}Y_{0.02}W₂O₈ were obtained in accordance with the substitution amount of yttrium Y.

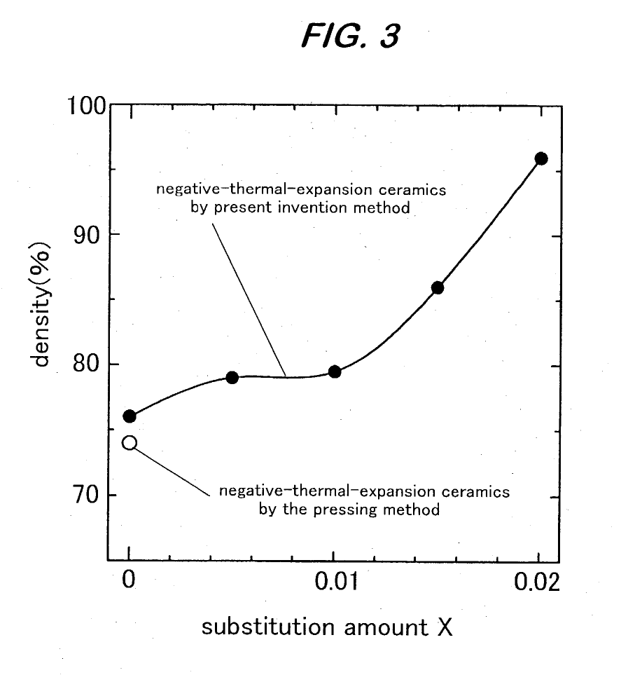

FIG. 3 is a graph showing a relation between the substitution amount x of yttrium Y and a density of negative-thermal-expansion ceramics. As a comparative example, a density of negative-thermal-expansion ceramics ZrW₂O₈ sintered by the pressing method is shown.

By conditioning the particle size distribution into two groups comprising smaller diameter particles with a particle size of 0.1 to 1 μm and larger diameter particles with a particle size of 5 to 50 μm, the density was equal with or higher than that of the negative-thermal-expansion ceramics ZrW₂O₈ obtained by the pressing method and the density reached 76% of the theoretical density.

Further, at the substitution amount x for the zirconium Zr of 0.005 or more, the density is about 80% of the theoretical density which is higher than that of the negative-thermal-expansion ceramics ZrW₂O₈ by the pressing method, and the density exceeds 80% of the theoretical density at the substitution amount X of 0.01 or more, exceeds 85% of the theoretical density at the substitution amount of x of 0.015 or more and, further, reaches 96% of the theoretical density at the substitution amount x of 0.02.

Further, the starting powder mixed for 2 hours and the starting powder mixed for 24 hours in the automatic mortar had a particle size distribution with a peak appearing only for the smaller diameter particles with a particle size of 0.1 to 1 μm. When sintered by the same procedures, they produced porous products in which a great amount of pores (voids) were formed inside of the sintering body, and those products of higher density than that of the negative-thermal-expansion ceramics ZrW₂O₈ by the pressing method were not obtained and they were fragile also in view of strength.

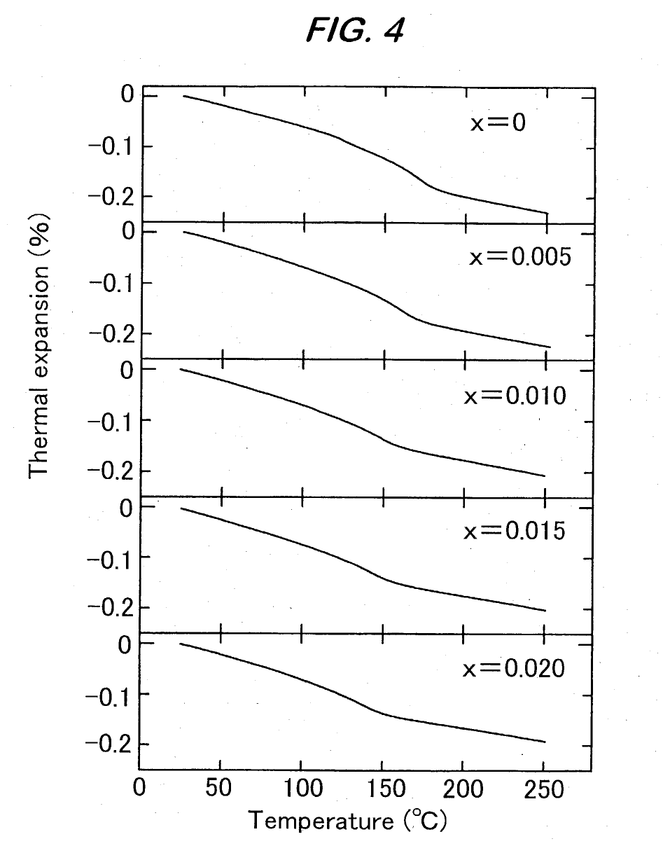

FIG. 4 is a graph showing the negative thermal expansion behavior of the obtained negative-thermal-expansion ceramics. The negative thermal expansion behavior is substantially constant irrespective of the substitution amount of yttrium Y and it has been confirmed that each of them has negative thermal expansion coefficient and the length was caused to shrink by about 0.2% when heated from the room temperature (25° C.) to 250° C.

In the foregoings, while the description has been made to a case of substituting zirconium Zr with yttrium Y, the present invention is not restricted thereto but is applicable also to a case of synthesizing negative-thermal-expansion ceramics by using other elements capable of substituting zirconium Zr, for example, scandium Sc or indium In.

As has been described above, the present invention can provide an excellent effect capable of synthesizing negative-thermal-expansion ceramics of a large size and at high density without press molding the starting powder, by merely grouping the starting powder to such a particle size distribution including two groups of smaller diameter particles with a particle size of 0.1 to 1 μm and larger diameter particles with a particle size of 5 to 50 μm and sintering them in a crucible or the like.

The present disclosure relates to subject matter contained in priority Japanese Patent Application No. 2002-149,551 filed on May 23, 2002, the contents of which is herein expressly incorporated by reference in its entirety.

What is claimed is:

1. A method of synthesizing negative-thermal-expansion ceramics of synthesizing Zr₍₁₋ₓ₎XₓW₂O₈ in which X represents a substituent element for zirconium Zr, and 0≦x<<1, having a negative thermal expansion coefficient, the method comprising mixing two mols of tungsten trioxide WO₃ and one mol of the sum of zirconium oxide ZrO₂ and a substituent element X in accordance with substitution amount x at a stoichiometrical ratio, further mixing the thus obtained starting material in a powdery form having a particle size distribution including two groups of particles comprising smaller diameter particles with a particle size of 0.1 to 1 μm and larger diameter particles with a particle size of 5 to 50 μm, and then sintering the staring powder being placed in a desired molding die.

2. A method of synthesizing negative-thermal-expansion ceramics according to claim 1, wherein the substituent element is yttrium Y and the starting material is formed by mixing one mol of the sum of zirconium oxide ZrO₂ and yttrium oxide Y₂O₃ to two mols of tungsten trioxide WO₃ at a stoichiometrical ratio.

3. A method of synthesizing negative-thermal-expansion ceramics according to claim 1, wherein the particle size distribution is defined such that the number of particles with a particle size of 0.1 to 1 μm is 20 to 60% for the number of entire particles and the number of particles with a particle size of 5 to 50 μm is 20 to 50% for the number of entire particles.

4. A method of synthesizing negative-thermal-expansion ceramics according to claim 1, wherein the substitution amount x is from 0.005 to 0.02, more preferably, from 0.01 to 0.02 and, further preferably, 0.02.
